(19) United States
(12) Patent Application Publication
(10) Pub. No.: US 2016/0171535 A1
(43) Pub. Date: Jun. 16, 2016

(54) COMMUNICATION BASED PRODUCT REMARKETING

(71) Applicant: Facebook, Inc., Menlo Park, CA (US)

(72) Inventors: Lee Charles Linden, San Francisco, CA (US); Benjamin Lewis, San Francisco, CA (US); Dwight Ewing Crow, San Francisco, CA (US); Jonathan Shottan, San Francisco, CA (US); Peng Fan, Castro Valley, CA (US)

(21) Appl. No.: 14/569,275

(22) Filed: Dec. 12, 2014

(51) Int. Cl. G06Q 30/02; G06Q 50/00

(52) U.S. Cl. CPC G06Q 30/0255; G06Q 30/0269; G06Q 30/0264; G06Q 50/01

(57) ABSTRACT

The present disclosure relates, in part, to systems and methods that provide for identifying a purchase by a user and remarketing a product to the user. In particular, a system can analyze a portion of a social networking communication from a user and determine that the social networking communication references a purchase of a product by the user. The system can further identify a projected usage interval associated with the purchase and provide remarketing content to the user based on the purchase and in accordance with the usage interval.

### BACKGROUND

1. Technical Field

One or more embodiments relate generally to an online social networking system. More specifically, one or more embodiments relate to providing users of a social networking system with targeted advertising based on social networking communications.

2. Background and Relevant Art

A social networking system allows its users to connect to and communicate with other social networking system users. Each user may create a profile on a social networking system that corresponds to a user identity and may include information about each specific user, such as interests and demographic information. Because of the increasing popularity of social networking systems, as well as the increasing amount of user-specific information to which a social networking system has access, a social networking system may provide an ideal forum for advertisers to increase awareness about products or services.

Generally, advertisers may include third-party merchants (e.g., entities separate from the provider of a social network system). Many merchants provide merchant content (e.g., websites, applications) to promote and sell products and/or services outside of the social networking system. Merchants may desire to advertise to users within a social networking system to drive more user traffic to the merchant's content. For example, presenting advertisements to users within a social networking system can allow a merchant to gain increased public awareness for its products and/or services.

Merchants often rely on past purchases by a user when advertising products and/or services to the user. However, a typical merchant's awareness of a user's past purchases is extremely limited. In most cases, a merchant is only aware past purchases by the user from the merchant, and has no understanding of what products the user has purchased from other merchants/sources. Therefore, the merchant's advertising to the user is often ineffective and does not account for the user's full purchase history. To illustrate, a merchant may advertise a product to a user who already purchased the product from another source and, as a result, has no need of purchasing the product again from the merchant.

Additionally, many merchants often rely on personal information for a user or group of users when providing targeted advertisements to a particular user or group of users. In particular, merchants often advertise to a target demographic of users that are more likely to have an interest in a product associated with the merchants. Nevertheless, merchants often lack access to personal information and/or additional information that is useful in determining whether a user has an interest in a particular product. Thus, merchants often fail to advertise a product to a user in an efficient and effective way.

Accordingly, there are a number of disadvantages with conventional methods of providing targeted advertising to users.

### SUMMARY

One or more embodiments described herein provide benefits and/or solve one or more of the foregoing or other problems in the art with systems and methods for effectively advertising to users of a social networking system. In accordance with some embodiments, the present disclosure includes features for analyzing portions (e.g., text, stickers, images, videos) of a social networking communication, subject to a user's privacy settings, and determining purchase information based on the analysis of the social networking communication. Additionally, the present disclosure includes features for more effectively remarketing to a user based on purchase information derived from the social networking communication.

For example, a social networking system can include one or more components for analyzing a portion of a social networking communication from a user and determining that the social networking communication references a purchase of a product by the user. In some embodiments, determining that a social networking communication references a purchase of a product may provide a limited purchase history associated with the user with regard to the particular product (e.g., an identification of a purchased product by the user). Further, based on the referenced purchase, the system can identify a user interest in a particular product or type of product to more effectively market the product or related product to the user.

Furthermore, in addition to determining a reference to a purchase, the system may further generate or otherwise identify a usage interval associated with the purchase. In particular, the system can determine a usage interval associated with the purchased product in determining a time to more effectively remarket the product or a related product to the user. Timely remarketing the product or related product to the user based on a usage interval can result in more effective marketing of the product or related product to the user.

Additional features and advantages of the embodiments will be set forth in the description that follows, and in part will be obvious from the description, or may be learned by the practice of such exemplary embodiments. The features and advantages of such embodiments may be realized and obtained by way of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots) are used herein to illustrate optional features or operations that add additional features to embodiments of the disclosure. Such notation, however, should not be taken to mean that these are the only options or optional operations, and/or that blocks with solid borders are not optional in certain embodiments of the disclosure. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates a schematic diagram of a system for remarketing a product to a user in accordance with one or more embodiments of the present disclosure;

FIG. 2 illustrates a block diagram of an example environment for implementing the system of FIG. 1 in accordance with one or more embodiments of the present disclosure;

FIG. 3 illustrates an example user interface including a social networking communication in accordance with one or more embodiments of the present disclosure;

FIG. 4 illustrates another example user interface including a social networking communication in accordance with one or more embodiments of the present disclosure;

FIG. 5 illustrates a flow diagram of a method for remarketing a product to a user in accordance with one or more embodiments of the present disclosure;

FIG. 6 illustrates a block diagram of an example computing device in accordance with one or more embodiments of the present disclosure;

FIG. 7 illustrates an example network environment of a social networking system in accordance with one or more embodiments of the present disclosure; and

FIG. 8 illustrates a social graph in accordance with one or more embodiments.

### DETAILED DESCRIPTION

One or more embodiments of the present disclosure relate to systems and methods for remarketing products to users. In particular, one or more embodiments facilitate remarketing products to users based on references to purchases in social networking communications. For example, a social networking system can analyze a portion of a social networking communication from a user, subject to the privacy settings of the user. Based on the analysis of the portion, the system can determine that the social networking communication references a purchase of a product by the user (e.g., “I just bought the new iPhone!”). Additionally, the system can generate a usage interval associated with the purchase (e.g., a time interval representing the time the user is expected to wait to purchase the product or a similar product again). The system can further provide remarketing content to the user based on the purchase and in accordance with the usage interval.

Additionally, one or more embodiments may facilitate more efficient marketing of a product by identifying information associated with a purchase of a product. For example, the system can analyze text of a social networking communication from a user and determine that the social networking communication references a purchase of a product. The system may utilize, for example, natural language processing to effectively identify the purchase and/or identify any additional information associated with the purchase and the user. Thus, the system can effectively identify one or more purchases by the user and generate a limited purchase history associated with the user with regard to a particular product. Further, based on the referenced purchase, the system can identify a user interest in the product or type of product and effectively market the product or a related product to the user.

In addition to identifying a purchase of a product by the user, the system may timely remarket a product to the user by generating or otherwise identifying a usage interval associated with the purchase. For example, the system can determine a date when the user will have an interest in purchasing the product again. Additionally or alternatively, the system can determine a date when the user will have an interest in purchasing a related product. In generating or otherwise identifying the usage interval, the system may rely on personal information associated with the user on a social networking system. The system may further consider information about the product or related products in generating or identifying the usage interval. Using the usage interval, the system can timely remarket a product or related product to a user resulting in more effective marketing of the product to the user.

As used herein, the term “marketing” refers to advertising or marketing content associated with a particular product and provided to a user. In some embodiments, a product may be marketed to a particular user over a communication network, on a third-party website or application, or by way of a social networking system. Additionally, the term “remarketing” refers to advertising or marketing a product or products to a user based on one or more products that the user has previously bought. For example, a system may remarket a product to a user where the user has purchased the product or a related product at an earlier date. Further, “remarketing” may refer to advertising or marketing a product to a user after the product or a related product has been previously marketed to the user.

Additionally, a “social networking communication” refers to a communication made using a social networking system. For example, a social networking communication can be a post by a user to the user's social networking profile (e.g., to a timeline, wall, etc.), a post to another user's social networking profile, a comment on a social networking post, a private/direct message between social networking users using the social networking system, or other social networking communication posted, made, or sent by way of a social networking system. In addition, a “portion” of a social networking communication may refer to text, stickers, links, images, videos, other media type, or combination of media types that may make up a social networking communication.

Further, as used herein, the term “product” or “products” refers to both goods and services provided by one or more merchants. For example, a product can refer to a tangible good as well as a service.

In addition, as used herein, the term “content” refers to any form of digital data that may be transmitted over a communication network. For example, content can include, but is not limited to, web sites, web pages, digital media (e.g., audio, video, images), electronic documents, electronic communication messages, or any other digital content or combination of digital content. In addition, the term “third-party content” refers to content that is provided by a content source that is outside of a social networking system. As another example, “marketing content” or “remarketing content” can refer to any content provided to a user for advertising one or more products.

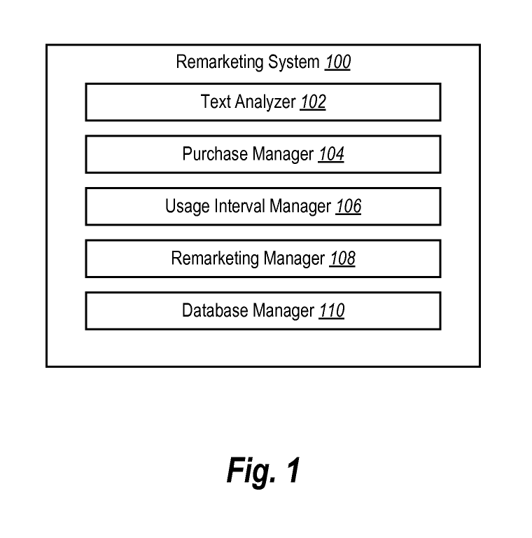

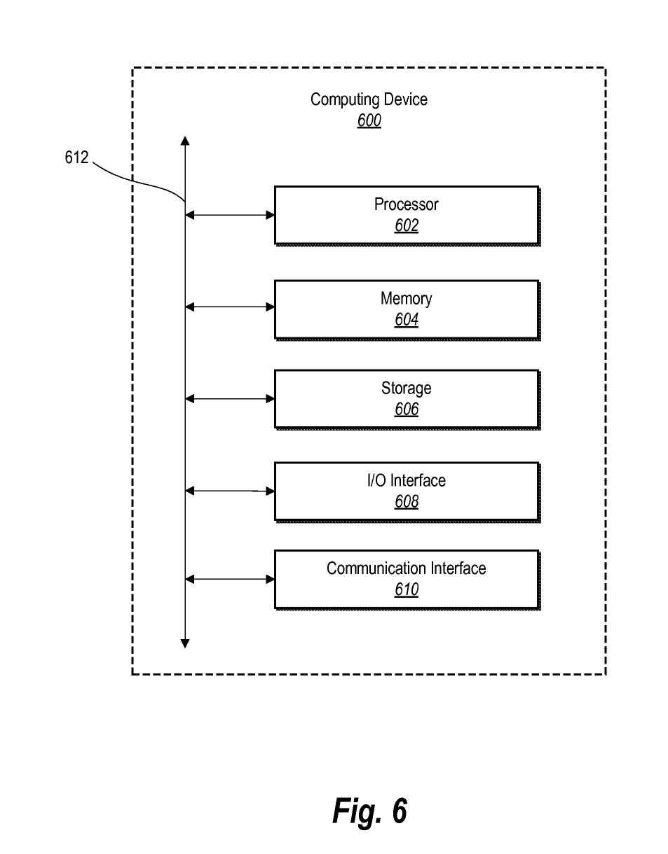

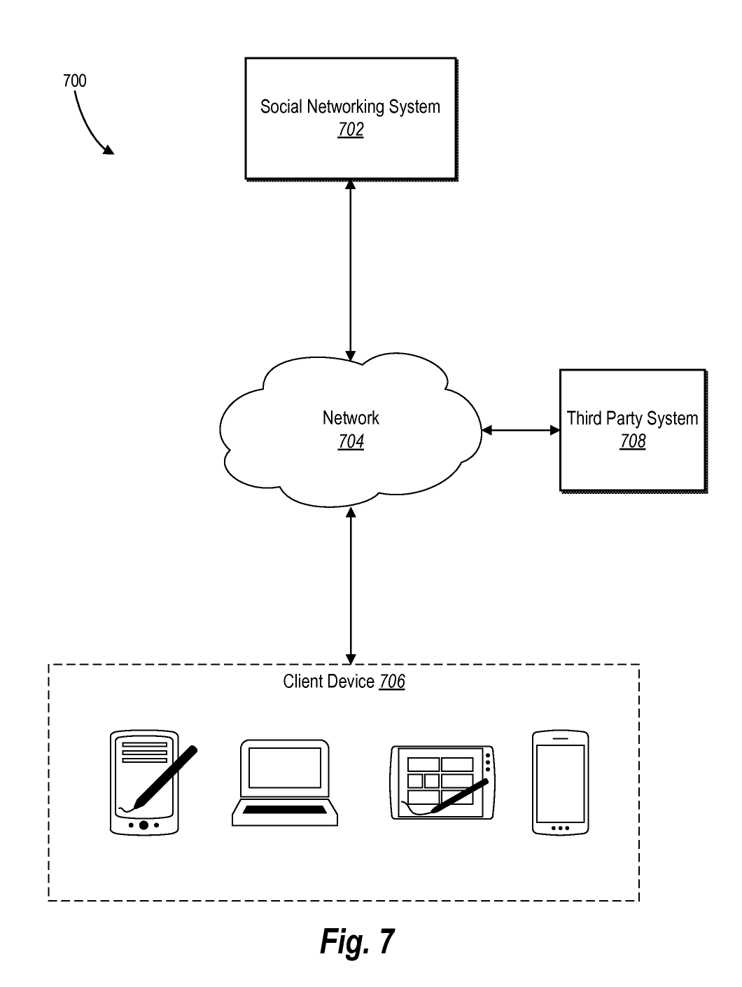

FIG. 1 illustrates an example embodiment of a remarketing system 100 (or simply “system”) in accordance with one or more principles described herein. As shown, the system 100 includes a text analyzer 102, a purchase manager 104, a usage interval manager 106, a remarketing manager 108, and a database manager 110. Each of the components 102-110 of the system 100 may be in communication with one another using any suitable communication technologies. It will be recognized that components 102-110 can be combined into fewer components, such as into a single component, or divided into more components as may serve a particular embodiment. Additionally, components 102-110 can be located on, or implemented by, one or more computing devices, such as those described below in relation to FIG. 6. Alternatively, portions of the system 100 can be implemented on a client device, while other portions of the system 100 can be implemented on a social networking system, such as described below in reference to FIG. 7.

The components 102-110 can include software, hardware, or a combination thereof. For example, the components 102-110 can include one or more instructions stored on a computer-readable storage medium and executable by one or more processors of one or more computing devices. When executed by the one or more processors, the computer-executable instructions of the system 100 can cause a computing device to perform the methods described herein. Alternatively, the components 102-110 can comprise hardware, such as a special purpose processing device to perform a certain function or group of functions. Additionally or alternatively, the components 102-110 can include a combination of computer-executable instructions and hardware.

As mentioned above, and as shown in FIG. 1, the system 100 can include a text analyzer 102 for analyzing one or more portions of social networking communications. For example, the text analyzer 102 can process, parse, evaluate, interpret, and/or otherwise analyze a text portion (or simply “text”) of a social networking communication in accordance with privacy settings of the user. The text analyzer 102 can analyze the text in a variety of ways. For example, in some embodiments, the text analyzer 102 can process the text using natural language processing. In particular, the text analyzer 102 can analyze the sentences, phrases, words, and numbers included within the text of the social networking communication using natural language processing methods to determine or otherwise derive a meaning from the text of the social networking communication.

In performing natural language processing, the text analyzer 102 can perform various types of analysis. For example, the text analyzer 102 can perform a syntactic analysis of the text of a social networking communication. In particular, the text analyzer 102 can analyze the sentence structure and determine a subject, predicate, and placement of different word types (e.g., nouns, verbs, pronouns). Additionally, the text analyzer 102 can determine the relationship between different words in the text of the social networking communication. The text analyzer 102 can further analyze the grammar and syntax of the text of the social networking communication and/or apply various types of parsing algorithms to determine relationships between words and/or otherwise derive a meaning of the text of the social networking communication.

In addition to performing a syntactic analysis of the text, the text analyzer 102 can further perform a semantic analysis of the text of the social networking communication. For example, the text analyzer 102 can analyze the text of the social networking communication and ascertain context and meaning of the text. In particular, the text analyzer 102 can produce a logical form of the text and/or map a phrase or sentence within the text into a logical form to facilitate determining an accurate meaning associated with the text.

In addition to the semantic analysis, the text analyzer 102 can perform a pragmatic analysis of the text of the social networking communication. In particular, the text analyzer 102 can consider various factors and further resolve ambiguities to derive a meaning associated with the text of the social networking communication. For example, the text analyzer 102 can user various techniques to resolve the meaning of indefinite articles, connect prepositional phrases with relevant terms, and perform various inferences in determining an accurate meaning associated with the text.

To illustrate, the text analyzer 102 might analyze the text of a communication and determine that the text includes the verb “purchase,” a derivative thereof, or a verb with a similar meaning (e.g., buy, lease, etc.). Additionally, the text analyzer 102 might identify the text and further determine that the text includes a product name (e.g., iPhone) or other noun describing the product (e.g., smartphone). Using this analysis, the system 100 can, subject to the user's privacy settings, determine that the communication references the purchase of the named product.

In addition to analyzing text of a social networking communication, the text analyzer 102 can further analyze other portions of the social networking communication. For example, the text analyzer 102 can analyze a sticker, image, video, link, or other portion of a social networking communication to process, parse, evaluate, interpret, and/or otherwise analyze a meaning of a social networking communication. In some embodiments, the text analyzer 102 can analyze the text in connection with other portions of the social networking communication. For example, in addition to analyzing the text, the text analyzer may further consider a sticker, image, video, link, or other media type included within the social networking communication to determine a meaning associated with the social networking communication. As on example, the text analyzer 102 can analyze metadata associated with an image in a social networking communication and/or use image recognition methods to identify a product within the image.

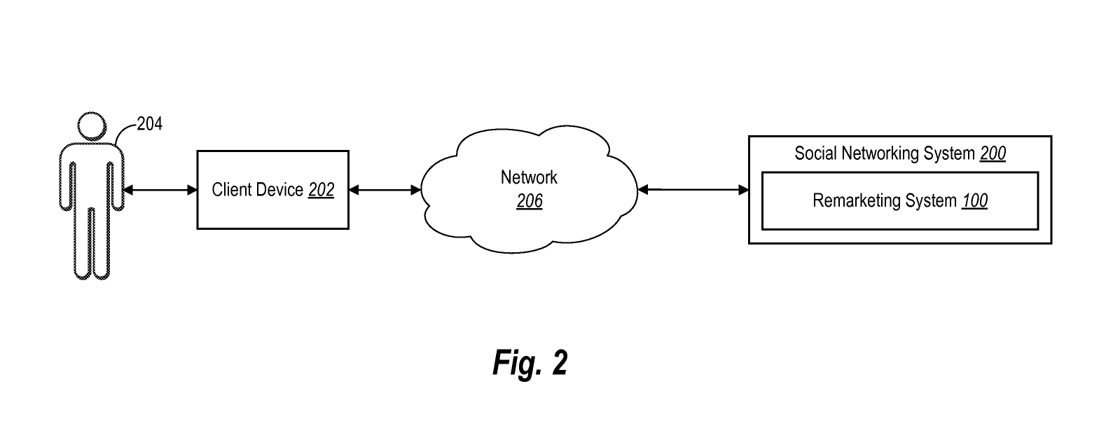

As mentioned above, and as shown in FIG. 2, the system 100 can further include a purchase manager 104. In particular, the purchase manager 104 can determine that the social networking communication references a purchase of a product by the user. For example, the purchase manager 104 can determine that the text references a purchase based on a meaning of the text derived from analysis of the text (e.g., and/or other portions) by the text analyzer 102. In some embodiments, the purchase manager 104 can determine that the text explicitly references a purchase by the user. Alternatively, the purchase manager 104 can determine that the text implicitly references a purchase by the user (e.g., based on a determined context of the text).

In determining that the text and/or other portion of the social networking communication references a purchase, the purchase manager 104 can identify information associated with the purchase. In particular, the purchase manager 104 can identify information about a product purchased by the user. For example, the purchase manager 104 can identify a product type, brand, name, model, or other descriptive information associated with the purchased product from the text of the social networking communication. Additionally or alternatively, the purchase manager 104 can identify additional information associated with the purchased product from sources other than the text and/or other portions within the social networking communication. For example, upon identifying the purchased product from the text of the social networking communication, the purchase manager 104 can access and/or receive additional information about the purchased product from a database of product information and/or a third-party website.

In some embodiments, the purchase manager 104 can further determine a date associated with the purchase. In particular, the purchase manager 104 can determine a date when the user purchased the product. For example, the purchase manager 104 can identify a date associated with the purchase from the text of the social networking communication. In particular, based on the analysis of the text, the purchase manager 104 can identify a reference in the social networking communication to when the user purchased the product. Alternatively, the purchase manager can identify a date of the purchase based on the date that the social networking communication was posted. For example, in the case that the text of the social networking communication does not include a reference to the date of the purchase, the purchase manager 104 can determine that the date of purchase is the same as the date that the social networking communication was posted.

In addition to determining a date associated with the purchase from the text or date of the social networking communication, the product manager 104 may further determine a date associated with the purchase and/or product based on additional information. In particular, the product manager 104 can, subject to privacy settings, access information from sources other than the social networking communication, such as information about a purchased product that is publicly known or accessible to a social networking system. For example, where a public release of a particular product occurs on a specific date, the product manager 104 may determine that the date of purchase corresponds with the public release of the product, or at some point after the public release of the product.

As mentioned above, and as shown in FIG. 1, the system 100 can include a usage interval manager 106 for generating a usage interval associated with the purchase. In particular, the interval manager 106 can generate and/or otherwise identify a date or period of time in which a user will have an interest in purchasing a similar product or related product to the purchased product referenced in the social networking communication. In some embodiments, the usage interval manager 106 can consider personal information associated with the user in determining the usage interval associated with the purchase (e.g., subject to privacy settings of the user). For example, the usage interval manager 106 can determine a usage interval based on personal information from a user profile associated with the user. Additionally or alternatively, the usage interval manager 106 can consider information about the purchased product in determining a usage interval associated with the purchase.

As mentioned above, the usage interval manager 106 can generate a usage interval based on a time or date when a user is likely to have an interest in purchasing a similar product as the purchased product referenced in the social networking communication. In particular, generating the usage interval can include estimating a future date when the user will have an interest in purchasing a similar product or repurchasing the same product as the purchased product. For example, the usage interval manager 106 may predict that the user will likely repurchase the same product in one year from the date of the purchase or have an interest in repurchasing the same product. Thus, the usage interval manager 106 may generate a usage interval corresponding to one year from the date of the referenced purchase from the social networking communication.

In some embodiments, the usage interval manager 106 can generate a usage interval corresponding to consumption of the purchased product. In particular, the usage interval manager 106 can determine a usage interval based on a period of time in which the user will consume the purchased product. In some embodiments, determining a usage interval based on consumption of a purchased product can include determining when a user will complete use of a purchased product and/or when a purchased product or service will expire. For example, a usage interval can refer to a predicted time in which a purchased product will be completely consumed or expired. Alternatively, a usage interval can refer to a time at which the user will no longer have access to a purchased product or service.

In determining a usage interval according to the consumption of the purchased product, the usage interval manager 106 can, subject to privacy settings, consider personal information associated with the user. For example, the usage interval manager 106 can include factors such as location, age, gender, family size or other personal information in determining a usage interval associated with a purchased product. As an example, the usage interval manager 106 may determine that a purchased product will have a shorter usage interval where a user has a family with multiple people who would participate in consumption of the purchased product. Additionally, the usage interval manager 106 may consider the age, gender, or other personal information associated with the user and any other users that may use and/or otherwise participate in the consumption of the purchased product.

In addition to considering personal information associated with a user (or related users), the usage interval manager 106 can consider information associated with a particular purchase or product. In particular, the purchased product may include one or more features or characteristics that may affect the determined usage interval. For example, certain products may be associated with a time interval, such as a contract or service agreement. New cell phones, for instance, are often associated with a one or two year agreement after which a user often upgrades or purchases a new cell phone. Therefore, where the social networking communication references a cell phone, the usage interval manager 106 may identify a one or two year usage interval associated with the purchased cell phone. In some embodiments, the usage interval manager 106 may identify a one or two year agreement for all phones generally. Alternatively, the usage interval manager 106 may consider the cell phone type, brand, or service provider of the purchased cell phone in identifying the precise usage interval.

In some embodiments, the usage interval manager 106 may generate multiple usage intervals for a purchase. For example, where limited information is available, the usage interval generator 106 may have difficulty determining when exactly a user is more likely to purchase a product or related product to the purchased product referenced in the social networking communication. In the case of a cell phone, for example, the usage interval manager 106 may determine that either a one or two year usage interval could apply. Thus, the usage interval manager 106 may generate a first usage interval of one year and a second usage interval of two years, each corresponding to common terms of service agreements for various cell phones.

Additionally, in some embodiments, the usage interval manager 106 can generate a usage interval based on a projected conversion rate associated with providing marketing content to a user. In particular, the usage interval manager 106 can determine a projected rate at which users purchase a product as a result of receiving marketing content for the product (e.g., a rate at which providing marketing content is converted to a user purchase). For example, the usage interval manager 106 can determine a projected conversion rate for advertising a product to a user within a range of dates. The usage interval manager may further determine a specific date or range of dates that correspond to a higher predicted conversion rate than other dates. Thus, the usage interval manager 106 may generate a usage interval based on a particular date or range of dates subsequent to the referenced purchase in which providing marketing content to a user would be most effective based on a projected conversation rate for the particular date or range of dates.

As mentioned above, and as shown in FIG. 1, the system 100 can further include a remarketing manager 108 for providing remarketing content to a user. In particular, the remarketing manager 108 can provide remarketing content to a user based on the referenced purchase and in accordance with the usage interval. In some embodiments, the remarketing manager 108 can provide remarketing content to the user via a social networking system. For example, in accordance with privacy settings of the user, the remarketing manager 108 can insert advertising content within a communication feed associated with the user. Additionally or alternatively, the remarketing manager 108 can present advertising content at any location within a display of a webpage or mobile application for the social networking system. Alternatively, the remarketing manager 108 can provide remarketing content in a variety of other ways. For example, the remarketing manager 108 can provide remarketing content by facilitating display of a banner or advertisement on a client device or otherwise facilitating delivery of an electronic communication (e.g., email, instant message). Alternatively, the remarketing manager 108 can facilitate delivery of remarketing content in other forms such as advertisements through the mail to a user's address.

In some embodiments, providing remarketing content to the user can include remarketing the same or similar product as the purchased product referenced in the social networking communication. In particular, the remarketing manager 108 can market the same product as previously purchased by the user. For example, where the previously purchased product is a pair of running shoes, the remarketing manager 108 can remarket the same pair of running shoes to the user based on the generated usage interval (e.g., one year). Alternatively, the remarketing manager 108 can market a similar product as the pair of previously purchased running shoes. For example, the remarketing manager 108 can market the newest version of the same brand of running shoes that was released during the usage interval.

In addition to remarketing the same or similar product to the user, the remarketing manager can remarket a similar product from a different merchant. For example, in the case where the purchase manager 104 determines that the social networking communication references a purchase associated with a particular merchant, the remarketing manager 108 can provide remarketing content to the user for a similar product associated with a competing merchant. Additionally, the remarketing manager 108 can provide the remarketing content in accordance with the usage interval with the intention of persuading a user to purchase a similar product associated with the competing merchant.

In some embodiments, rather than providing remarketing content for the same or similar product, the remarketing manager 108 can provide remarketing content for a related product to the purchased product referenced in the social networking communication. In particular, the remarketing manager 108 can remarket a related product based on a prediction that the user will have an interest in purchasing the related product subsequent to the referenced purchase. For example, where a user has purchased new ski equipment at the beginning of a ski season, including skis, boots, goggles, and other accessories, the user may have an interest in purchasing replacement equipment or additional accessories at the beginning of the next ski season. For instance, where the purchase manager 104 identifies a purchase of new skis, the remarketing manager 108 may provide remarketing content for different ski equipment, such as new boots, new insoles, or ski goggles in accordance with the usage interval (e.g., at the beginning of the next ski season).

As mentioned above, the remarketing manager 108 can provide remarketing content in accordance with the usage interval. In particular, the remarketing manager 108 can provide remarketing content to the user before, after, or upon completion of the usage interval. As an example, the remarketing manager 108 can provide remarketing content to the user upon completion of the usage interval as a user is likely to have an interest in purchasing a product or related product upon expiration of purchase, completing consumption, or otherwise using a purchased product after a particular period of time. Additionally or alternatively, in some embodiments, the remarketing manager 108 can provide remarketing content prior to completion of the usage interval as a way to remind the user of an upcoming need or interest in a particular product and thus increase the likelihood that the user will purchase the product or related product. Furthermore, in some embodiments, the remarketing manager 108 can provide additional remarketing content to a user some time after the usage interval as a follow up or reminder of the user's previous interest in a similar product or related product.

Additionally, as shown in FIG. 1, the system 100 can include a database manager 110. The database manager 110 can manage storage of information and/or access to information on the social networking system, including personal information associated with a user and information associated with purchases referenced in social networking communications. Additionally, the database manager 110 can store and/or provide access to additional information, such as information associated with products, merchants, and other users of the social networking system. In some embodiments, the database manager 110 can store information associated with various users and purchases on a database accessible to the system 100 and one or more client devices.

FIG. 2 illustrates a block diagram of an example environment for implementation of a communication remarketing system 100. In particular, FIG. 2 illustrates a client device 202 associated with a user 204. The client device 202 may be in communication with a social networking system 200 by way of a network 206. Alternatively, the client device 202 and one or more additional client devices may communicate with the social networking system 200 by way of one or more additional networks.

In some embodiments, functions and features described herein can be performed entirely on the social networking system 200. For example, the system 100 may be implemented within the social networking system 200. Alternatively, the client device 202 can perform one or more functions described with respect to the system 100. In some embodiments, the social networking system 200 and the client device 202 can perform a combination of different functions described herein. Moreover, functions and features described herein can be performed in accordance with privacy settings of a particular user 204. For example, in some embodiments, the social networking system 200 may analyze text, access profile information, and provide advertising content to the user 204 subject to privacy settings specified by or otherwise associated with the user 204. Furthermore, the user 204 can be given the option to opt in or out of the features described herein and provided by the disclosed systems.

As illustrated in FIG. 2, the user can communicate with the social networking system 200 by way of the client device 202. The client device 202 can include various types of computing devices. For example, the client device 202 can include a mobile device such as a mobile telephone, a smartphone, a PDA, a tablet, a laptop, or a non-mobile device such as a desktop, server, or other computing device. Additional details with respect to the client device 202 are discussed below with respect to FIG. 6.

In some embodiments, a social networking system 200 can receive social networking communications from a user 204 by way of the client device 202. In particular, using the client device 202, the user 204 can post a message including text, photographs, videos, or other media to a social networking system 200. For example, the user 204 can compose a social networking communication using the client device 202 and provide the social networking communication to the social networking system 200 over the network 206. In the social networking communication, the user 204 can include text about a recent purchase, including a product name, description, or a link to a third-party website associated with the purchase.

Upon receiving the social networking communication, the social networking system 200 can publish the social networking communication. In particular, the social networking system 200 can manage communication feeds associated with the user and other users in accordance with privacy settings and provide the social networking communication within the communication feed for other users of the social networking system to view. For example, subject to user privacy settings, the social networking system 200 can publish the social networking communication to a communication feed associated with the user 204 that is accessible only to other users of the social networking system 200 that are friends with or otherwise associated with the user 204. Alternatively, the social networking system 200 can publish the social networking communication on a communication feed that is accessible to the public or other interested users. For example, in some embodiments, the social networking system 200 can publish the social networking communication to a communication feed associated with a particular product or merchant.

In addition to publishing the social networking communication, the system 100 can analyze text and/or other portions of the social networking communication from the user 204. In particular, the system 100 can analyze the text and other portions of the social networking communication using a variety of processes and determine or otherwise derive a meaning from the social networking communication. In some embodiments, the system 100 can analyze the text using natural language processing. For example, the system 100 can determine structure, context, and relationships between words to determine a meaning associated with the social networking communication. Additionally, the system 100 can perform other processes on the text or other portions to determine a meaning associated with the social networking communication.

Upon processing one or more portions of the social networking communication and determining or otherwise identifying a meaning associated with the social networking communication, the system 100 can determine that one or more portions of the social networking communication references a purchase. In particular, the system 100 can determine that the social networking communication references a purchase of a particular product based on the analysis of the portions of the social networking communication. In some embodiments, the system 100 can further identify additional information associated with the purchase or the product, such as a date of the purchase and a name, brand, model, or other descriptive information associated with the purchased product.

In addition to determining that the social networking communication references a purchase of a product, the system 100 can further determine a usage interval associated with the purchase. In particular, the system 100 can predict a date or range of dates in which a user 204 will have an interest in repurchasing the purchased product and/or purchasing a similar or related product. In some embodiments, the system 100 may determine the usage interval based on a projected conversion rate from remarketing the product to a user 204 and the user 204 purchasing the product. For example, the system 100 may determine a date subsequent to the purchase when the user 204 is most likely to repurchase the purchased product and/or purchase a similar or related product.

Determining the usage interval can include considering information associated with the purchase and/or purchased product. For example, the system 100 can consider a contract or service agreement associated with the referenced purchase. In some embodiments, the system 100 can consider information associated with the purchase and/or referenced product provided in the social networking communication, such as a date of purchase, product name, product model, product specs, or other descriptive information provided in the social networking communication. Alternatively, the system 100 can consider other information (e.g., publicly known information) about the purchased product in determining the usage interval.

Additionally, the system 100 can determine a usage interval based on personal information associated with the user 204 that is accessible to the social networking system 200. In particular, the system 100 can consider a purchase history, user profile information, or other information accessible to the social networking system 200 in determining when a user 204 will consume a product and/or when the user 204 will most likely have an interest in repurchasing the purchased product or purchasing a similar or related product. In some embodiments, the system 100 can consider any information accessible to the social networking system 200. Additionally or alternatively, the system can consider information received from other sources.

In addition to determining the usage interval, the system 100 can facilitate remarketing content to the user 204 based on the purchase and in accordance with the usage interval. In particular, the social networking system 200 can provide remarketing content to the client device 202 based on the purchase and in accordance with the usage interval. For example, the social networking system 202 can provide remarketing content to a communication feed associated with the user 204. Additionally or alternatively, the social networking system 200 can provide other types of remarketing content to a user 204 by way of the client device 202 such as a banner, advertisement, email, instant message, or other electronic communication.

In addition to providing different types of remarketing content, the social networking system 200 may provide remarketing content for different products in accordance with the usage interval. For example, the social networking system 200 can provide remarketing content associated with the same product as the purchased product or a similar product from a different merchant. The social networking system 200 can further provide remarketing content for a related product. Furthermore, in providing the remarketing content in accordance with the usage interval, the social networking system 200 can provide the remarketing content for the various products to the user 204 before, after, and/or upon completion of the usage interval.

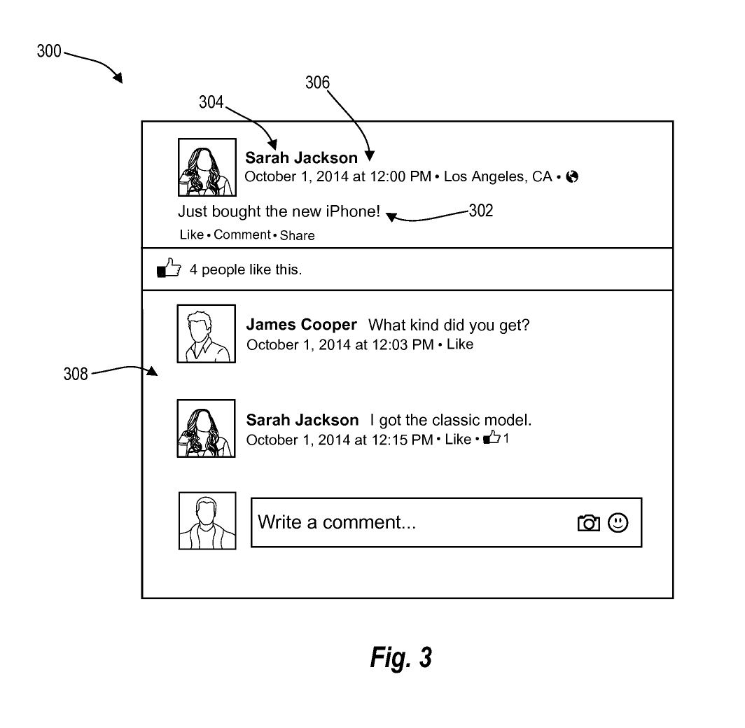

FIG. 3 illustrates one example of a user interface for presenting a social networking communication 300. In particular, the social networking communication 300 can include a text portion 302 (or simply “text 302”) and a user identification 304 associated with the social networking communication 300. Further, the social networking communication 300 can include a date 306 and a comment section 308. In some embodiments, the social networking communication can be provided to a user 204 on a display of a client device 202. Additionally, the social networking communication can be provided to one or more other users of the social networking system 200 on one or more additional client devices. Further, while not illustrated in FIG. 3, the social networking communication 300 can include one or more additional portions including stickers, images, videos, or other media types.

As illustrated in the example user interface of FIG. 3, the social networking communication 300 can include text 302. Further, the system 100 can analyze the text 302 using natural language processing. Based on the analysis, the system 100 can determine that the text 302 references a purchase of a product by the user 204. For example, as illustrated in FIG. 3, the text includes the phrase “Just bought the new iPhone!” Using an analysis including natural language processing, the system 100 can determine that the text 302 references a purchase of a new iPhone. In some embodiments, the system 100 can limit analysis to the text 302 of the initial social networking communication 300. Alternatively, the system 100 can further consider text or other portions of one or more comments 308 by the user and/or one or more additional users in response to the text 302 of the initial social networking communication 300 in identifying the purchase and/or the exact product associated with the purchase. For example, as illustrated in FIG. 3, the comment section 308 includes a first comment from another user asking “what kind did you get?” followed by a response from the user answering “I got the classic model.” Thus, the system 100 can identify that the user 204 purchased the “classic model” of the iPhone.

In addition to determining that the text 302 references a purchase of an iPhone, the system 100 can further identify or determine additional information about the purchase. For example, the social networking communication 300 can include a date 306 associated with the social networking communication 300. As shown in FIG. 3, the social networking communication 300 includes a date and time of “Oct. 1, 2014 at 12:00 pm.” In some embodiments, the system 100 can determine that the date of the purchase is the same as the day that the social networking communication 300 was created or posted. Thus, in the illustrated example of FIG. 3, the system 100 can determine that the purchase by the user was made on Oct. 1, 2014.

In some embodiments, the system 100 can determine that the purchase was carried out on a different date than the date 306 of the social networking communication 300. For example, the text 302 may explicitly describe or reference the date of the purchase. Additionally, one or more comments or responses in the comment section 308 may include text that references the purchase or date of the purchase. Based on text within the social networking communication 300 or comments in the comment section, the system 100 can determine that the user 204 made the purchase on a specific date other than the date of the social networking communication 300.

In some embodiments, the system 100 can consider information from other sources, such as publicly known information or information accessed on a third-party website in determining the purchase date of a product. For example, where a product has a public release date, the system 100 can access information about the public release and determine or assume that the user 204 purchased a product on the public release date. To illustrate, in the example social networking communication 300 of FIG. 3, the system 100 may determine that a public release of the iPhone is on a specific date and determine that the date of the purchase most likely corresponds to the public release of the iPhone referenced in the text 302 of the social networking communication 300.

In addition to determining that the text 302 references a purchase of an iPhone, the system 100 can further determine a usage interval associated with the purchase. For example, in the illustrated example of FIG. 3, the system 100 may determine that a common contract or service agreement term for an iPhone is two years. Thus, the system 100 can identify a usage interval of two years based on the identified purchase of the iPhone. Alternatively, rather than identifying a typical length of a contract or service agreement, the system 100 may consider a time period in which a typical user exchanges an iPhone. For example, where many users trade in an iPhone for an upgrade after a year, the system 100 may determine a usage interval corresponding to one year. In some embodiments, the system 100 may identify multiple usage intervals.

Additionally, as described above, the system 100 can provide remarketing content to a user 204 based on the referenced purchase and in accordance with the usage interval. For example, in accordance with illustrated example of FIG. 3, the system 100 can provide remarketing content to the user 204 for a new iPhone after two years from the date 306 of the social networking communication 300. Additionally or alternatively, the system 100 can provide remarketing content to the user for a similar phone (e.g., a phone associated with a competing merchant) or accessories or other related products to the iPhone.

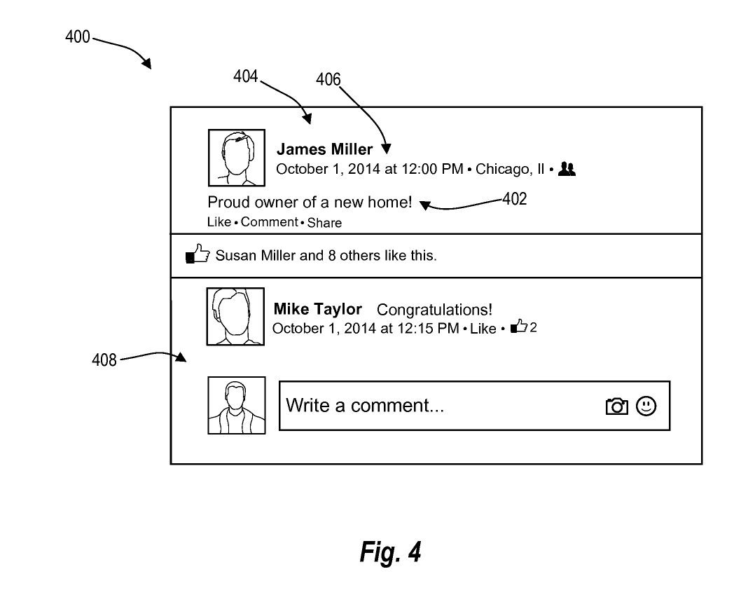

FIG. 4 illustrates another example of a user interface for presenting a social networking communication 400. In particular, the social networking communication 400 can include a text portion 402 (or simply “text 402”) and a user identification 404 associated with the social networking communication 400. Further, the social networking communication 400 can include a date 406 and a comment section 408. Similar to the example of FIG. 3, the social networking communication 400 can be provided to a user 204 on a display of a client device 202.

As illustrated in the example user interface of FIG. 4, the social networking communication 400 can include text 402. Further, the system 100 can analyze the text 402 and determine that the text 402 references a purchase of a product by the user 204. For example, as illustrated in FIG. 4, the text 402 includes the phrase “Proud owners of a new home!” followed by one comment in the comment section 408 including the phrase “Congratulations!” Based on the analysis of the text 402 and/or comments 408, the system 100 can determine that the text 402 references a purchase of a new house.

In addition to determining that the text 402 references a purchase of a house, the system 100 can further identify or determine additional information about the purchase, such as a date associated with the social networking communication 400. As shown in FIG. 4, the social networking communication 400 includes a date of “Oct. 1, 2014 at 12:00 pm.” Thus, based on the date 406 of the social networking communication 400, the system 100 can determine that the date of the purchase of the house is the same as the day that the social networking communication 400 was created or posted. In the illustrated example of FIG. 4, the system 100 can determine that the purchase by the user 204 was made on October 1. Alternatively, the system 100 can determine that the house was purchased on another day. For example, while not shown in FIG. 4, the text 402 or comment section 408 may include additional information to indicate a different date of the purchase.

In addition to determining that the text 402 references a purchase of a new home, the system 100 can further determine a usage interval associated with the purchase of the home. In particular, the system 100 can determine that users who have purchased new homes commonly purchase one or more related products after a period of time. For example, in the illustrated example of FIG. 4, the system 100 may determine that many new homeowners purchase new furniture after six months of buying a new home. Thus, the system 100 can identify a usage interval of six months for the purchase of the new home based on the likelihood that the user will have an interest in buying new furniture in about six months after the purchase of the new home. Additionally, the system 100 can identify one or more additional usage intervals for other related products associated with the purchase of the new home. For example, the system 100 may determine multiple usage intervals for multiple related products based on the purchase of the new home.

Additionally, as described above, the system 100 can provide remarketing content to the user 204 based on the referenced purchase and in accordance with the usage interval. For example, in accordance with the example of FIG. 4, the system 100 can provide remarketing content to the user 204 for new furniture after six months from the date of the social networking communication 400. Additionally, the system 100 can provide remarketing content to the user 204 for any number of related products in accordance with respective usage intervals.

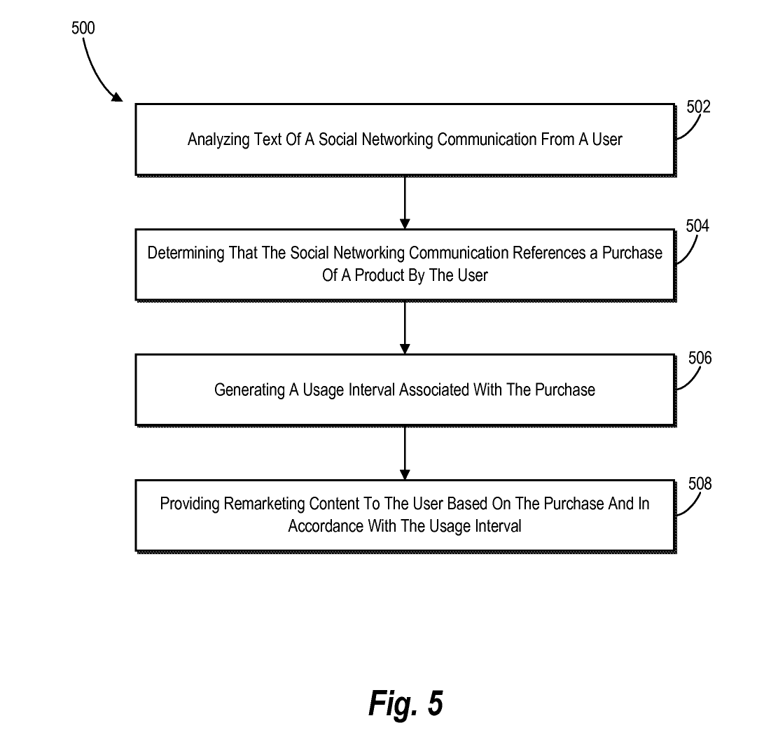

FIG. 5 illustrates a flow diagram of an example method 500 for effectively remarketing a product to a user 204. While FIG. 5 illustrates example steps according to one embodiment, other embodiments may omit, add to, reorder, and/or modify any of the steps shown in FIG. 5. One or more steps shown in FIG. 5 may be performed by any one of the components illustrated in the communication remarketing system 100 illustrated in FIG. 1. Further, one or more steps of the method 500 can be performed by a client device 202, social networking system 200 or a combination of both.

As illustrated in FIG. 5, the method 500 includes step 502, which may include analyzing text (e.g., a text portion) or other portion of a social networking communication from a user 204. In particular, the system 100 can analyze a text portion (or simply “text”) of the social networking communication, subject to a user's privacy settings, using natural language processing. For example, the system 100 can process sentences, phrases, words, and numbers included within the text of a social networking communication and to determine or otherwise derive meaning from the social networking communication. In some embodiments, the social networking communication can include a post on a communication feed by a user 204 and/or one or more replies to a post by the user 204. Alternatively, the social networking communication can include a post on a communication feed associated with the user 204 composed by another user of the social networking system 200 having access to the user's 204 communication feed.

As illustrated in FIG. 5, the method 500 further includes step 504, which may include determining that the social networking communication references a purchase of a product by the user 204. In particular, the system 100 may determine that the social networking communication references a purchase of a product based on the analysis of the text. For example, the text of the social networking communication may explicitly reference the purchase of the product and information associated with the purchase and/or product. In some embodiments, the text of the social networking communication can reference the date of the purchase. Alternatively, the system 100 may determine that the date of the purchase corresponds to the date of the social networking communication.

As illustrated in FIG. 5, the method 500 further includes step 506, which may include generating a usage interval associated with the purchase. In particular, the system 100 can generate a usage interval based one or a combination of various factors. For example, the system 100 can generate a usage interval by estimating a future date when the user 204 will have an interest in purchasing the product or related product. Additionally or alternatively, the system 100 can generate the usage interval by determining a time interval in which the user 204 will consume the product. Additionally, in some embodiments, the system 100 can generate a usage interval based on a time interval associate with the product (e.g., an expiration date or completion of contract). Additionally, the system 100 can generate a usage interval based on a projected conversion rate associated with providing remarketing content to the user 204.

As illustrated in FIG. 5, the method 500 further includes step 508, which may include providing remarketing content to the user 204 based on the purchase and in accordance with the usage interval. In particular, the system 100 can provide remarketing content to a user 204 by way of a client device 204 or via a social networking system 200. In some embodiments, providing remarketing content to a user can include remarketing the purchased product to the user 204. Additionally or alternatively, providing remarketing content to the user 204 can include marketing a related product to the user 204.

Additionally, as mentioned above, the system 100 can provide remarketing content to the user 204 in accordance with the usage interval. For example, the system 100 can provide remarketing content to the user 204 for a similar or related product upon completion of the usage interval. Alternatively, the system 100 can provide remarketing content to the user 204 for a similar or related product prior to completion of the usage interval. In some embodiments, the system 100 can provide remarketing content to a user 204 in accordance with multiple usage intervals.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) could be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing Environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the communication remarketing system 100. As shown by FIG. 6, the computing device 600 can comprise a processor 602, a memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the system 100 can comprise a social networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social-networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia content items to a user's profile page (typically known as “wall posts” or “timeline posts”) or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similarly to events, the calendar entries may include times, dates, locations and identities of other users.

FIG. 7 illustrates an example network environment 700 of a social-networking system. Network environment 700 includes a client system 706, a social-networking system 702, and a third-party system 708 connected to each other by a network 704. Although FIG. 7 illustrates a particular arrangement of client system 706, social-networking system 702, third-party system 708, and network 704, this disclosure contemplates any suitable arrangement of client system 706, social-networking system 702, third-party system 708, and network 704. As an example and not by way of limitation, two or more of client system 706, social-networking system 702, and third-party system 708 may be connected to each other directly, bypassing network 704. As another example, two or more of client system 706, social-networking system 702, and third-party system 708 may be physically or logically co-located with each other in whole or in part. Moreover, although FIG. 7 illustrates a particular number of client systems 706, social-networking systems 702, third-party systems 708, and networks 704, this disclosure contemplates any suitable number of client systems 706, social-networking systems 702, third-party systems 708, and networks 704. As an example and not by way of limitation, network environment 700 may include multiple client system 706, social-networking systems 702, third-party systems 708, and networks 704.

This disclosure contemplates any suitable network 704. As an example and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client system 706, social-networking system 702, and third-party system 708 to communication network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client system 706 may be an electronic device including hardware, software, or embedded logic components or a combination of two or more such components and capable of carrying out the appropriate functionalities implemented or supported by client system 706. As an example and not by way of limitation, a client system 706 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 706. A client system 706 may enable a network user at client system 706 to access network 704. A client system 706 may enable its user to communicate with other users at other client systems 706.

In particular embodiments, client system 706 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 706 may enter a Uniform Resource Locator (URL) or other address directing the web browser to a particular server (such as server, or a server associated with a third-party system 708), and the web browser may generate a Hyper Text Transfer Protocol (HTTP) request and communicate the HTTP request to server. The server may accept the HTTP request and communicate to client system 706 one or more Hyper Text Markup Language (HTML) files responsive to the HTTP request. Client system 706 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 702 may be a network-addressable computing system that can host an online social network. Social-networking system 702 may generate, store, receive, and send social-networking data, such as, for example, user-profile data, concept-profile data, social-graph information, or other suitable data related to the online social network. Social-networking system 702 may be accessed by the other components of network environment 700 either directly or via network 704. In particular embodiments, social-networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social-networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 706, a social-networking system 702, or a third-party system 708 to manage, retrieve, modify, add, or delete, the information stored in data store.

In particular embodiments, social-networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social-networking system 702 may provide users of the online social network the ability to communicate and interact with other users. In particular embodiments, users may join the online social network via social-networking system 702 and then add connections (e.g., relationships) to a number of other users of social-networking system 702 whom they want to be connected to. Herein, the term “friend” may refer to any other user of social-networking system 702 with whom a user has formed a connection, association, or relationship via social-networking system 702.

In particular embodiments, social-networking system 702 may provide users with the ability to take actions on various types of items or objects, supported by social-networking system 702. As an example and not by way of limitation, the items and objects may include groups or social networks to which users of social-networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 702 or by an external system of third-party system 708, which is separate from social-networking system 702 and coupled to social-networking system 702 via a network 704.

In particular embodiments, social-networking system 702 may be capable of linking a variety of entities. As an example and not by way of limitation, social-networking system 702 may enable users to interact with each other as well as receive content from third-party systems 708 or other entities, or to allow users to interact with these entities through an application programming interfaces (API) or other communication channels.

In particular embodiments, a third-party system 708 may include one or more types of servers, one or more data stores, one or more interfaces, including but not limited to APIs, one or more web services, one or more content sources, one or more networks, or any other suitable components, e.g., that servers may communicate with. A third-party system 708 may be operated by a different entity from an entity operating social-networking system 702. In particular embodiments, however, social-networking system 702 and third-party systems 708 may operate in conjunction with each other to provide social-networking services to users of social-networking system 702 or third-party systems 708. In this sense, social-networking system 702 may provide a platform, or backbone, which other systems, such as third-party systems 708, may use to provide social-networking services and functionality to users across the Internet.

In particular embodiments, a third-party system 708 may include a third-party content object provider. A third-party content object provider may include one or more sources of content objects, which may be communicated to a client system 706. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 702 also includes user-generated content objects, which may enhance a user's interactions with social-networking system 702. User-generated content may include anything a user can add, upload, send, or “post” to social-networking system 702. As an example and not by way of limitation, a user communicates posts to social-networking system 702 from a client system 706. Posts may include data such as status updates or other textual data, location information, photos, videos, links, music or other similar data or media. Content may also be added to social-networking system 702 by a third-party through a “communication channel,” such as a newsfeed or stream.

In particular embodiments, social-networking system 702 may include a variety of servers, sub-systems, programs, modules, logs, and data stores. In particular embodiments, social-networking system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 702 may also include suitable components such as network interfaces, security mechanisms, load balancers, failover servers, management-and-network-operations consoles, other suitable components, or any suitable combination thereof. In particular embodiments, social-networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 702 to one or more client systems 706 or one or more third-party system 708 via network 704. The web server may include a mail server or other messaging functionality for receiving and routing messages between social-networking system 702 and one or more client systems 706. An API-request server may allow a third-party system 708 to access information from social-networking system 702 by calling one or more APIs. An action logger may be used to receive communications from a web server about a user's actions on or off social-networking system 702. In conjunction with the action log, a third-party-content-object log may be maintained of user exposures to third-party-content objects. A notification controller may provide information regarding content objects to a client system 706. Information may be pushed to a client system 706 as notifications, or information may be pulled from client system 706 responsive to a request received from client system 706. Authorization servers may be used to enforce one or more privacy settings of the users of social-networking system 702. A privacy setting of a user determines how particular information associated with a user can be shared. The authorization server may allow users to opt in to or opt out of having their actions logged by social-networking system 702 or shared with other systems (e.g., third-party system 708), such as, for example, by setting appropriate privacy settings. Third-party-content-object stores may be used to store content objects received from third parties, such as a third-party system 708. Location stores may be used for storing location information received from client systems 706 associated with users. Advertisement-pricing modules may combine social information, the current time, location information, or other suitable information to provide relevant advertisements, in the form of notifications, to a user.

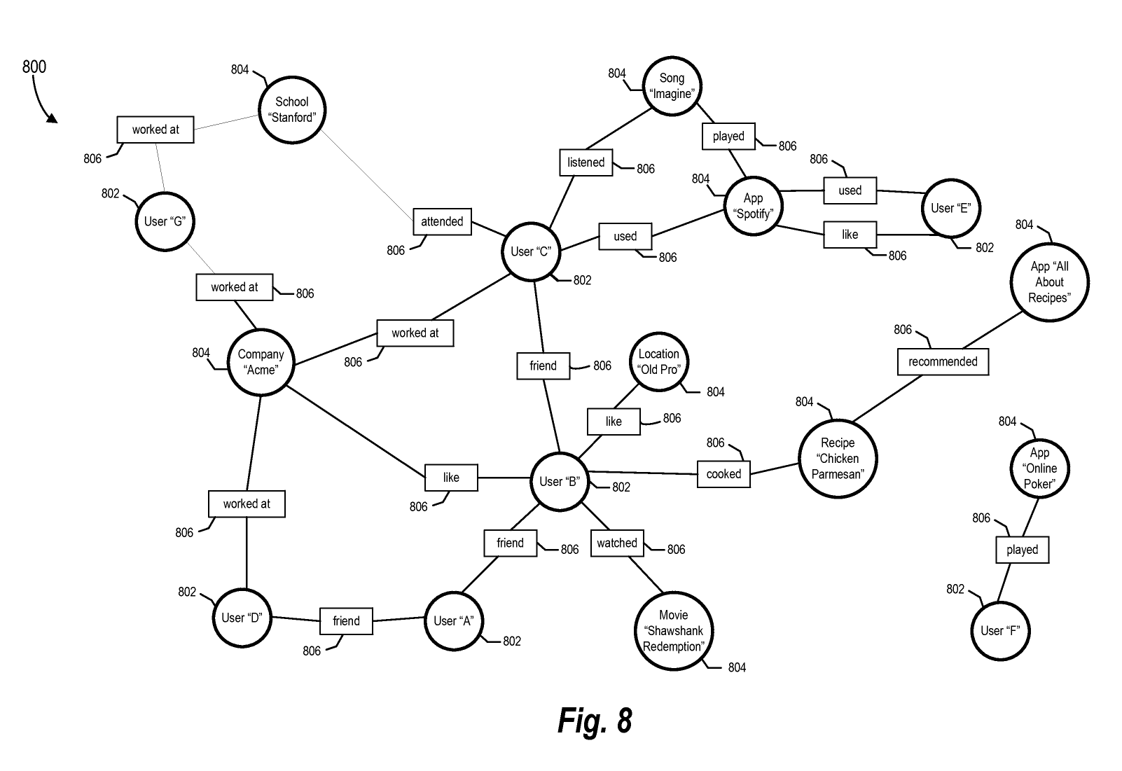

FIG. 8 illustrates example social graph 800. In particular embodiments, social-networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social-networking system 702, client system 706, or third-party system 708 may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of social-networking system 702. As an example and not by way of limitation, a user may be an individual (human user), an entity (e.g., an enterprise, business, or third-party application), or a group (e.g., of individuals or entities) that interacts or communicates with or over social-networking system 702. In particular embodiments, when a user registers for an account with social-networking system 702, social-networking system 702 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social-networking system 702. In particular embodiments, a user node 802 may be associated with information provided by a user or information gathered by various systems, including social-networking system 702. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 702 or a third-party website associated with a web-application server); a product (such as, for example, a product purchased by one or more users); an entity (such as, for example, a person, business, group, sports team, or celebrity); a resource (such as, for example, an audio file, video file, digital photo, text file, structured document, or application) which may be located within social-networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including social-networking system 702. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social-networking system 702. Profile pages may also be hosted on third-party websites associated with a third-party server 708. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 708. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 706 to send to social-networking system 702 a message indicating the user's action. In response to the message, social-networking system 702 may create an edge (e.g., an “eat” edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social-networking system 702 may send a “friend request” to the second user. If the second user confirms the “friend request,” social-networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship, follower relationship, visitor relationship, subscriber relationship, superior/subordinate relationship, a purchase of a product by a user, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to a edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social-networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social-networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social-networking system 702 may create an edge 806 between a user node 802 and a concept node 804 in social graph 800. As an example and not by way of limitation, a user viewing a concept-profile page (such as, for example, by using a web browser or a special-purpose application hosted by the user's client system 706) may indicate that he or she likes the concept represented by the concept node 804 by clicking or selecting a “Like” icon, which may cause the user's client system 706 to send to social-networking system 702 a message indicating the user's liking of the concept associated with the concept-profile page. In response to the message, social-networking system 702 may create an edge 806 between user node 802 associated with the user and concept node 804, as illustrated by “like” edge 806 between the user and concept node 804. In particular embodiments, social-networking system 702 may store an edge 806 in one or more data stores. In particular embodiments, an edge 806 may be automatically formed by social-networking system 702 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 702 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 702) or RSVP (e.g., through social-networking system 702) to an event associated with the advertisement. In addition or as an alternative, an advertisement may include social-networking-system context directed to the user. As an example and not by way of limitation, an advertisement may display information about a friend of the user within social-networking system 702 who has taken an action associated with the subject matter of the advertisement.

In particular embodiments, social-networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 708 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 702 may calculate a coefficient based on a user's actions. Social-networking system 702 may monitor such actions on the online social network, on a third-party system 708, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 702 may calculate a coefficient based on the user's actions with particular types of content. The content may be associated with the online social network, a third-party system 708, or another suitable system. The content may include users, profile pages, posts, news stories, headlines, instant messages, chat room conversations, emails, advertisements, pictures, video, music, other suitable objects, or any combination thereof. Social-networking system 702 may analyze a user's actions to determine whether one or more of the actions indicate an affinity for subject matter, content, other users, and so forth. As an example and not by way of limitation, if a user may make frequently posts content related to “coffee” or variants thereof, social-networking system 702 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 702 may calculate a coefficient based on the type of relationship between particular objects. Referencing the social graph 800, social-networking system 702 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 702 may determine that the user has a higher coefficient with respect to the first photo than the second photo because having a tagged-in-type relationship with content may be assigned a higher weight and/or rating than having a like-type relationship with content. In particular embodiments, social-networking system 702 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 702 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, social-networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 706 of the user). A first user may be more interested in other users or concepts that are closer to the first user. As an example and not by way of limitation, if a user is one mile from an airport and two miles from a gas station, social-networking system 702 may determine that the user has a higher coefficient for the airport than the gas station based on the proximity of the airport to the user.

In particular embodiments, social-networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to ra nk and order such objects, as appropriate. In this way, social-networking system 702 may provide information that is relevant to user's interests and current circumstances, increasing the likelihood that they will find such information of interest. In particular embodiments, social-networking system 702 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 702 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 708 (e.g., via an API or other communication channel), or from another suitable system. In response to the request, social-networking system 702 may calculate the coefficient (or access the coefficient information if it has previously been calculated and stored). In particular embodiments, social-networking system 702 may measure an affinity with respect to a particular process. Different processes (both internal and external to the online social network) may request a coefficient for a particular object or set of objects. Social-networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. patent application Ser. No. 12/978265, filed 23 Dec. 2010, and U.S. patent application Ser. No. 13/632869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by social-networking system 702 or shared with other systems (e.g., third-party system 708). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 708, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social-networking system 702 may send a request to the data store for the object. The request may identify the user associated with the request and may only be sent to the user (or a client system 706 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
analyzing, by a social networking system, a portion of a social networking communication from a user;
determining, based on the analysis of the portion of the social networking communication, that the social networking communication references a purchase of a product by the user;
generating a usage interval associated with the purchase;
providing remarketing content to the user based on the purchase and in accordance with the usage interval.

2. The method of claim 1, wherein analyzing the portion of the social networking communication comprises analyzing a text portion of the social networking communication using natural language processing.

3. The method of claim 1, wherein the social networking communication comprises a post to a user profile associated with the user.

4. The method of claim 1, wherein determining that the social networking communication references a purchase comprises identifying a reference to a purchased product from the portion of the social networking communication.

5. The method of claim 1, wherein determining that the social networking communication references a purchase comprises determining a date associated with the purchase.

6. The method of claim 5, wherein determining a date associated with the purchase comprises identifying a reference to a date of the purchase in the portion of the social networking communication.

7. The method of claim 1, wherein generating a usage interval comprises estimating a future date when the user will have an interest in purchasing the product or a related product.

8. The method of claim 1, wherein generating a usage interval comprises determining a time interval in which the user will consume the product.

9. The method of claim 1, wherein generating a usage interval comprises identifying a time interval associated with the product.

10. The method of claim 1, wherein generating a usage interval is further based on a projected conversion rate associated with providing remarketing content to the user.

11. The method of claim 1, wherein generating a usage interval comprises estimating a consumption interval based on personal information associated with the user.

12. The method of claim 1, wherein providing remarketing content to the user comprises marketing the same product to the user.

13. The method of claim 1, wherein providing remarketing content to the user comprises marketing a related product to the user.

14. The method of claim 1, wherein providing remarketing content to the user in accordance with the usage interval comprises providing remarketing content to the user upon completion of the usage interval.

15. The method of claim 1, wherein providing remarketing content to the user in accordance with the usage interval comprises providing remarketing content to the user prior to completion of the usage interval.

16. A system comprising:
at least one processor; and
at least one non-transitory computer readable storage medium storing instructions thereon that, when executed by the at least one processor, cause the system to:
analyze a portion of a social networking communication from a user;
determine, based on the analysis of the portion of the social networking communication, that the social networking communication references a purchase of a product by the user;
generate a usage interval associated with the purchase;
provide remarketing content to the user based on the purchase and in accordance with the usage interval.

17. The system of claim 16, wherein the instructions further cause the system to access additional information about the product from a third-party website.

18. The system of claim 17, wherein generating a usage interval comprises determining a date associated with the purchase based on the additional information about the product from the third-party website.

19. The system of claim 18, wherein generating a usage interval comprises determining a time interval in which the user will consume the product based on the additional information about the product from the third-party website.

20. The system of claim 18, wherein generating a usage interval comprises identifying a time interval associated with the product based on the additional information about the product from the third-party website.
